(19) United States
(12) Patent Application Publication
(10) Pub. No.: US 2026/0282085 A1
(43) Pub. Date: Sep. 17, 2026

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/471,255

(22) PCT Filed: Apr. 6, 2023
(86) PCT No.: PCT/CN2023/086732

§ 371 Date: Sep. 30, 2025

(51) Int. Cl. H04W 74/0808

(52) U.S. Cl. CPC H04W 74/0808

(57) ABSTRACT

A method, including: determining a first multi-user request-to-send transmission opportunity sharing (MU-RTS TXS) trigger frame, where the first MU-RTS TXS trigger frame is configured to indicate sharing of transmission duration of a transmission opportunity (TXOP) obtained by a first access point (AP) with at least one second AP; and sending the first MU-RTS TXS trigger frame.

### CROSS-REFERENCE TO RELATED APPLICATION

The present application is a U.S. National Stage of International Application No. PCT/CN2023/086732, filed on Apr. 6, 2023, the contents of all of which are incorporated herein by reference in their entirety for all purposes. INNBXM-PT330

### BACKGROUND OF THE INVENTION

In an existing wireless fidelity (Wi-Fi) technology, after obtaining a transmission opportunity (TXOP), an AP allocates the obtained TXOP to an associated station (STA) via a multi-user request-to-send (MU RTS) TXOP sharing (TXS) trigger frame, such that the associated STA performs non-trigger-based (Non-TB) data transmission or peer-to-peer (P2P) data transmission.

### SUMMARY OF THE INVENTION

Embodiments of the present disclosure relate to the technical field of communication, and particularly relate to a communication method and apparatus, a device, and a storage medium.

In a first aspect, an embodiment of the present disclosure provides a communication method. The communication method may be applied to a first AP and includes: determining a first MU-RTS TXS trigger frame, where the first MU-RTS TXS trigger frame is configured to indicate sharing of transmission duration of a TXOP obtained by the first AP with at least one second AP; and sending the first MU-RTS TXS trigger frame.

In a second aspect, an embodiment of the present disclosure provides a communication method. The communication method may be applied to a target AP and includes: receiving a first MU-RTS TXS trigger frame, where the first MU-RTS TXS trigger frame is configured to indicate sharing of transmission duration of a TXOP obtained by a first AP with at least one second AP, and the target AP is any second AP.

In a third aspect, an embodiment of the present disclosure provides a communication method. The communication method may be applied to a target STA and includes: setting a network allocation vector to be in a busy state in a case of receiving a first MU-RTS TXS trigger frame sent by a first AP, where the first MU-RTS TXS trigger frame is configured to indicate sharing of transmission duration of a TXOP obtained by the first AP with at least one second AP, and the target STA is associated with any second AP.

In a fourth aspect, an embodiment of the present disclosure provides an electronic device. The electronic device includes a memory, one or more processors, and a computer program stored on the memory and capable of being run on the one or more processors. The one or more processors, when executing the program, collectively implement any communication method provided in an embodiment of the present disclosure.

In a fifth aspect, an embodiment of the present disclosure provides a non-transitory computer-readable storage medium. The non-transitory computer-readable storage medium stores a computer program. The computer program, when collectively executed by one or more processors, implements any communication method provided in an embodiment of the present disclosure.

Some of the additional aspects and advantages of the embodiments of the present disclosure are given in the following descriptions, and become apparent from the following descriptions or can be learned via practices of the present disclosure.

### BRIEF DESCRIPTION OF DRAWINGS

To describe the technical solutions in the embodiments of the present disclosure more clearly, the accompanying drawings required to be used in the descriptions of the embodiments of the present disclosure are briefly introduced below. Apparently, the accompanying drawings in the following descriptions show merely some embodiments of the present disclosure. A person of ordinary skill in the art can derive other accompanying drawings according to these accompanying drawings without making creative efforts.

FIG. 1 is a schematic structural diagram of a communication system according to an embodiment of the present disclosure.

FIG. 2 is a schematic interactive diagram of a communication method according to an embodiment of the present disclosure.

FIG. 3 is another schematic interactive diagram of a communication method according to an embodiment of the present disclosure.

FIG. 4 is a flowchart of a communication method according to an embodiment of the present disclosure.

FIG. 5 is another flowchart of a communication method according to an embodiment of the present disclosure.

FIG. 6 is yet another flowchart of a communication method according to an embodiment of the present disclosure.

FIG. 7 is a schematic structural diagram of a communication device according to an embodiment of the present disclosure.

FIG. 8 is another schematic structural diagram of a communication device according to an embodiment of the present disclosure.

FIG. 9 is yet another schematic structural diagram of a communication device according to an embodiment of the present disclosure.

FIG. 10 is a schematic structural diagram of an electronic device according to an embodiment of the present disclosure.

### DETAILED DESCRIPTION OF THE INVENTION

The term “and/or” in the embodiments of the present disclosure describing an association relationship between associated objects indicates that there can be three relationships. For instance, A and/or B can denote A alone, both A and B, and B alone. The character “/” generally denotes an “or” relationship between the associated objects.

It can be understood that the term “plurality of” in the embodiments of the present disclosure refers to two or above, and other quantifiers are understood in a similar way.

Examples are described in detail here and are illustratively stated in accompanying drawings. When the following descriptions involve accompanying drawings, unless otherwise indicated, the same numerals in different accompanying drawings denote the same or similar elements. Implementations described in the following examples do not denote all implementations consistent with the present disclosure. On the contrary, the embodiments are merely instances of a device and a method consistent with some aspects of the present disclosure as detailed in the appended claims.

The terms used in the present disclosure are merely configured to describe the particular embodiments, and are not intended to limit the present disclosure. The singular forms such as “a,” “an,” “the” and “this” used in the present disclosure and the appended claims are also intended to include the plural forms, unless otherwise clearly stated in the context. It should further be understood that the term “and/or” used here refers to and includes any or all possible combinations of one or more of the associated listed items.

It should be understood that although the terms “first,” “second,” “third,” etc. may be employed in the present disclosure to describe various types of information, such information should not be limited to these terms. These terms are merely configured to distinguish the same type of information from each other. For instance, without departing from the scope of the present disclosure, first information may alternatively be referred to as second information. Similarly, second information may alternatively be referred to as first information. Depending on the context, the word “if” used here can be interpreted as “when,” “in a case where,” or “in response to determining.”

The technical solutions of the embodiments of the present disclosure are clearly and completely described in combination with the accompanying drawings of the embodiments of the present disclosure. Apparently, the described embodiments are merely some embodiments rather than all embodiments of the present disclosure. Based on the embodiments of the present disclosure, all other embodiments derived by a person of ordinary skill in the art without making creative efforts all fall within the scope of protection of the present disclosure.

The method and the device are based on the same disclosed concept. Since the principles of resolving problems of the method and the device are similar, the implementations of the device and the method can be obtained with reference to each other. Repetitions are not described.

As the Wi-Fi technology has been constantly developed, ultra-high reliability (UHR), a next-generation Wi-Fi technology, has been developed by researchers. In the UHR technology, the AP can share the transmission duration of the obtained TXOP with other APs, such that Non-TB data transmission or P2P data transmission can be performed by the associated STA throughout the transmission duration that can be obtained by other APs. However, how the AP shares the transmission duration of the obtained TXOP with other APs is not clear in the prior art.

Embodiments of the present disclosure provide a communication method and apparatus, a device, and a storage medium, which can provide a method for sharing, by an AP, transmission duration of an obtained TXOP with another AP.

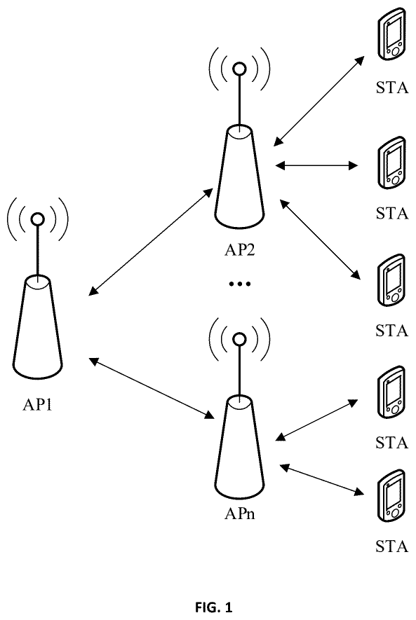

With reference to FIG. 1, a schematic structural diagram of a communication system according to an embodiment of the present disclosure is shown in FIG. 1. The system architecture includes a plurality of APs, such as AP1, AP2, . . . , and APn shown in FIG. 1. Each AP may be associated with at least one STA.

The AP in an embodiment of the present disclosure may be an independent device not attached to any AP multi-link device (MLD), or may be an AP attached to the AP MLD, or the AP MLD may be regarded as the AP in an embodiment of the present disclosure. This is not limited here.

The STA may be an independent device not attached to any non-AP MLD, or may be an STA attached to the non-AP MLD, or the non-AP MLD may be regarded as the STA in an embodiment of the present disclosure. This is not limited here.

A first AP may determine and transmit a first multi-user request-to-send a transmission opportunity sharing (MU-RTS TXS) trigger frame. The first MU-RTS TXS trigger frame is configured to indicate the sharing of the transmission duration of a TXOP obtained by the first AP with at least one second AP. For instance, the first AP may be AP1, and the second AP may be AP2-APn.

Any second AP (referred to as a target AP in an embodiment of the present disclosure) may receive the first MU-RTS TXS trigger frame and determine the transmission duration allocated to the second AP by the first AP. Further, the second AP may send a second MU-RTS TXS trigger frame to share the obtained transmission duration with an associated STA, to perform non-trigger-based (Non-TB) data transmission or peer-to-peer (P2P) data transmission with the associated STA.

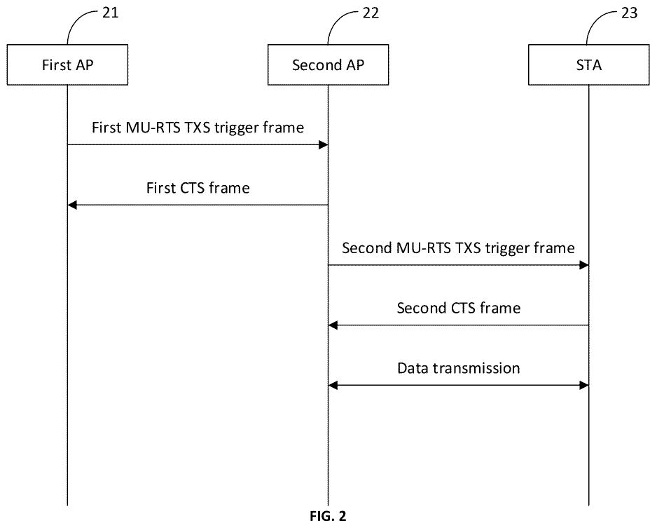

The communication method provided in an embodiment of the present disclosure is further described below in combination with FIG. 2.

After obtaining the TXOP, the first AP 21 may send the first MU-RTS TXS trigger frame to the at least one second AP 22, to share the transmission duration of the obtained TXOP with the at least one second AP 22.

The transmission duration shared by the first AP 21 with each second AP 22 is configured for Non-TB data transmission or P2P data transmission between the corresponding second AP 22 and the associated STA 23.

The first MU-RTS TXS trigger frame includes a triggered TXOP sharing mode field. An identifier value of the triggered TXOP sharing mode field is 3, which is configured to indicate the sharing of the transmission duration of the TXOP obtained by the first AP 21 with the at least one second AP 22.

The first MU-RTS TXS trigger frame includes at least one user information field. Each user information field of the first MU-RTS TXS trigger frame includes an association identifier (AID) field, a resource unit (RU) allocation information field, and an allocation duration information field.

An RU allocation information field of each user information field of the first MU-RTS TXS trigger frame is configured to indicate an RU allocation method corresponding to the corresponding second AP. The allocation duration information field is configured to indicate transmission duration allocated to the corresponding second AP.

In a case where the first MU-RTS TXS trigger frame is configured to indicate sharing of the transmission duration of the TXOP with one second AP, a receiving address of the first MU-RTS TXS trigger frame is a MAC address of the target AP, and an identifier value of the association identifier field of the user information field of the first MU-RTS TXS trigger frame is a preset value. For instance, the preset value may be 2059. In a case where the first MU-RTS TXS trigger frame is configured to indicate sharing of the transmission duration of the TXOP with a plurality of second APs, the receiving address of the first MU-RTS TXS trigger frame is a broadcast address corresponding to each second AP. Moreover, an association identifier field of a user information field of the first MU-RTS TXS trigger frame corresponding to each second AP is configured to indicate an association identifier allocated by the first AP to the corresponding second AP in advance.

In terms of any second AP, if the second AP supports a 160-MHz channel, a format of a user information field of the first MU-RTS TXS trigger frame corresponding to the second AP is a first format. If the second AP supports a 320-MHz channel, the format of the user information field of the first MU-RTS TXS trigger frame corresponding to the second AP is a second format. If the second AP supports a 480-MHz channel, the format of the user information field of the first MU-RTS TXS trigger frame corresponding to the second AP is the second format. An identifier value of a second identifier bit of a reserved bit of the user information field is 0, which is configured to indicate that the second user information field shares the transmission duration of the TXOP with the AP supporting the 480-MHz channel. If the second AP supports a 640-MHz channel, the format of the user information field of the first MU-RTS TXS trigger frame corresponding to the second AP is the second format. An identifier value of a second identifier bit of the reserved bit of the user information field is 1, which is configured to indicate that the second user information field shares the transmission duration of the TXOP with the AP supporting the 640-MHz channel.

If the second AP supports the 160-MHz channel or the 320-MHz channel, in a case where an identifier value of a third identifier bit of the RU allocation information field of the user information field of the first MU-RTS TXS trigger frame corresponding to the second AP is 0, it indicates that primary channels of the second AP are a 20-MHz channel, a 40-MHz channel, and an 80-MHz channel. In a case where the identifier value is 1, it indicates that the primary channels of the second AP are the 160-MHz channel, an (80+80)-MHz channel, and the 320-MHz channel. If the second AP supports the 480-MHz channel or the 640-MHz channel, in a case where the identifier value of the third identifier bit of the RU allocation information field of the user information field of the first MU-RTS TXS trigger frame corresponding to the second AP is 0, it indicates that the primary channel of the second AP is the 480-MHz channel. In a case where the identifier value is 1, it indicates that the primary channel of the second AP is the 640-MHz channel.

The third identifier bit and the fourth identifier bit are different bits in the RU allocation information field, for instance, may be bit B0 and bit B1 in the RU allocation information field.

In terms of any second AP, after the second AP receives the first MU-RTS TXS trigger frame sent by the first AP, the second AP may transmit a first CTS frame to the first AP, to respond to the first MU-RTS TXS trigger frame.

Further, in terms of any second AP, after determining the transmission duration allocated to the second AP by the first AP, the second AP may send a second MU-RTS TXS trigger frame to at least one associated STA, to share obtained transmission duration with the at least one associated STA.

The second MU-RTS TXS trigger frame includes at least one user information field. Each second user information field of the second MU-RTS TXS trigger frame corresponds to one associated STA, to share the transmission duration obtained by the second AP with the associated STA.

Further, in terms of an associated STA of any second AP, after receiving a MU-RTS TXS trigger frame, the associated STA may parse the MU-RTS TXS trigger fram and determine, using a related parameter (such as the association identifier field of the user information field) in the MU-RTS TXS trigger frame, whether the STA is a receiver of the MU-RTS TXS trigger frame. In a case where the STA determines that the STA is not the receiver of the received MU-RTS TXS trigger frame, that is, determines that the MU-RTS TXS trigger frame is sent not by the second AP associated with the STA, the STA may set a network allocation vector (NAV) to be in a busy state, and then continues to keep a monitoring state.

When receiving a second MU-RTS TXS trigger frame set by the second AP associated with the STA, the STA sends a second CTS frame to the corresponding second AP. The second CTS frame is configured to respond to the second MU-RTS TXS trigger frame sent by the corresponding second AP. Further, the STA may determine the transmission duration, which is allocated to the STA by the corresponding second AP via the second MU-RTS TXS trigger frame, to perform Non-TB data transmission or P2P data transmission with the second AP based on the transmission duration.

The transmission duration shared by the first AP with each second AP is part of the transmission duration of the TXOP obtained by the first AP. The transmission duration obtained by each associated STA is part of or all of the target transmission duration. That is, the transmission duration obtained by each associated STA is less than or equal to the target transmission duration.

The target transmission duration is less than or equal to the difference between the transmission duration obtained by the target AP and the first transmission duration. The first transmission duration is a sum of the transmission duration of the first MU-RTS TXS trigger frame, the transmission duration of the first CTS frame, and double short inter-frame spaces (SIFS).

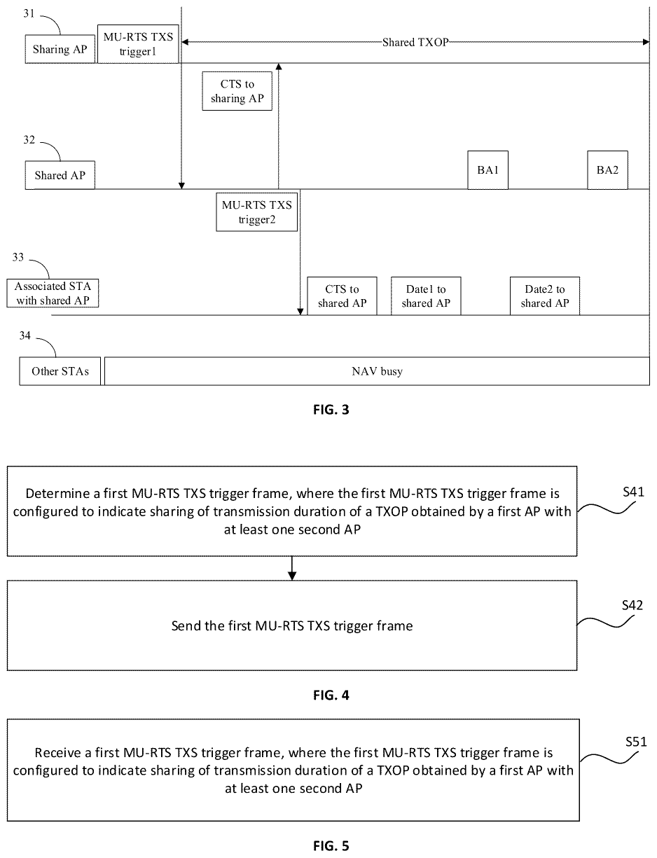

For instance, as shown in FIG. 3, a sharing AP 31 sends the first MU-RTS TXS trigger frame (MU-RTS TXS trigger 1) to a shared AP 32, to share a TXOP (shared TXOP) obtained by the sharing AP 31 with the shared AP 32. After receiving MU-RTS TXS trigger 1, the shared AP 32 replies to the sharing AP 31 with a CTS frame (CTS to sharing AP) for acknowledgement, and may share transmission duration obtained by the shared AP 32 from the sharing AP 31 with an associated STA (associated STA with shared AP 33) via the second MU-RTS TXS trigger frame (MU-RTS TXS trigger 2).

In this case, transmission duration T1 (that is, duration indicated by the allocation duration information field of the user information field of MU-RTS TXS trigger 2) shared by the shared AP with the associated STA may be expressed as follows:

$${T}_{1} = {T}_{2} - ( {T}_{3} + {T}_{4} + 2 SIFS ) .$$

Specifically, T₂ is the transmission duration shared by the sharing AP with the shared AP, T₃ is the transmission duration of MU-RTS TXS trigger 1, T₄ is the transmission duration of the CTS frame replied by the shared AP to the sharing AP, and SIFS is a short inter-frame space of the CTS frame and the MU-RTS TXS trigger frame.

In terms of an STA associated with the shared AP, the STA may transmit data to the shared AP within the transmission duration allocated to the STA by the shared AP. After receiving the data transmitted by the associated STA, the shared AP is required to send a block acknowledgement (BA) frame to the associated STA to indicate that the data sent by the associated STA has been received.

For instance, the STA associated with the shared AP transmits data 1 to the shared AP within the transmission duration allocated to the STA by the shared AP. The shared AP replies with BA1 (a first block acknowledgement frame) after receiving data 1. The STA associated with the shared AP continues to transmit data 2 to the shared AP within the transmission duration allocated to the STA by the shared AP. The shared AP replies with BA2 (a second block acknowledgement frame) after receiving data 2.

When the sharing AP shares the TXOP with the shared AP and the shared AP shares the transmission duration with the associated STA, other STAs 34 not associated with the shared AP sets a network allocation vector (NAV) to be in a busy state and to not participate in the above sharing process.

An embodiment of the present disclosure provides a communication method. The method may be applied to a first AP. Details can be obtained with reference to FIG. 4, a flowchart of a communication method according to an embodiment of the present disclosure is shown in FIG. 4. In some examples, the method may include the following steps S41 and S42.

In step S41, a first MU-RTS TXS trigger frame is determined, where the first MU-RTS TXS trigger frame is configured to indicate sharing of transmission duration of a TXOP obtained by the first AP with at least one second AP.

The first AP may share at least part of the transmission duration of the TXOP obtained by the first AP with each second AP via the first MU-RTS TXS trigger frame.

The transmission duration shared by the first AP with each second AP is configured for Non-TB data transmission or P2P data transmission between the second AP and the associated STA.

The first AP and the second AP in an embodiment of the present disclosure are different physical entities. That is, the first AP is an AP other than the second AP.

In step S42, the first MU-RTS TXS trigger frame is sent.

An embodiment of the present disclosure provides a communication method. Using the method, any AP can share the transmission duration of an obtained TXOP with another AP via a MU-RTS TXS trigger frame, such that the other AP can share the obtained transmission duration with an associated STA via the MU-RTS TXS trigger frame for data transmission.

In a case where the first AP shares the transmission duration of the TXOP obtained by the first AP with one second AP, the first AP may send the first MU-RTS TXS trigger frame based on a communication connection with the second AP. In a case where the first AP shares the transmission duration of the TXOP obtained by the first AP with a plurality of second APs, the first AP may send the first MU-RTS TXS trigger frame to each second AP based on a broadcast method.

In the communication method applied to the first AP provided in an embodiment of the present disclosure, the first MU-RTS TXS trigger frame includes a first identifier bit. The first identifier bit indicates, using a first value, the sharing of the transmission duration of the TXOP obtained by the first AP with the at least one second AP.

In some examples, the first MU-RTS TXS trigger frame includes a triggered TXOP sharing mode field. The triggered TXOP sharing mode field includes the first identifier bit. In a case where the identifier value of the first identifier bit of the first MU-RTS TXS trigger frame is the first value, it indicates the sharing of the transmission duration of the TXOP obtained by the first AP with the at least one second AP.

In a case where an identifier value of the triggered TXOP sharing mode field of the MU-RTS TXS trigger frame is 0, it indicates that a MU-RTS TXOP sharing process is not initiated.

In a case where the identifier value of the triggered TXOP sharing mode field is 1, that is, in TXOP sharing mode 1, it indicates that the MU-RTS TXOP sharing process is initiated. The STA supports only sending of addressing to a media access control protocol data unit (MPDU) of an associated AP.

In a case where the identifier value of the triggered TXOP sharing mode field is 2, that is, in TXOP sharing mode 2, it indicates that the MU-RTS TXOP sharing process is initiated. The STA supports sending of addressing to an MPDU of an associated AP or to an MPDU of another STA.

In a case where the identifier value of the triggered TXOP sharing mode field is 3 (the first value), that is, in TXOP sharing mode 3, it indicates sharing of the obtained TXOP with at least one other AP.

As an instance, a specific format of the first MU-RTS TXS trigger frame may be expressed as follows:

| | | | | | | B20 B21 | B22 | B23 B25 |
|---|---|---|---|---|---|---|---|---|
| | | | | | | Triggered | MU- | Number Of HE- |
| | B0 B3 | B4 B15 | B16 | B17 | | TXOP | MIMO | LTF Symbols And |
| | Trigger | Ul | More | CS | B18 B19 | Sharing | HE-LTF | Midamble |
| | Type | Length | TF | Required | UL BW | Mode | Mode | Periodicity |
| Bits | 4 | 12 | 1 | 1 | 2 | 2 | 1 | 3 |

| | | B27 | | B34 B35 | | | | |
|---|---|---|---|---|---|---|---|---|
| | | LDPC | | Pre- | | B37 B52 | | B54 B62 |
| | B26 | Extra | B28 B33 | FEC | B36 | UL | | EL HE- |
| | UL | Symbol | AP Tx | Padding | PE | Spatial | B53 | SIG-A2 |
| | STBC | Segment | Power | Factor | Disambiguity | Reuse | Doppler | Reserved |
| Bits | 1 | 1 | 6 | 2 | 1 | 16 | 1 | 9 |

| | B27 |
|---|---|
| | Trigger |
| B63 | Dependent |
| Reserved | Common Info |
| Bits 1 | variable |

Specifically, fields B20 and B21 are the triggered TXOP sharing mode field. In a case where an identifier value corresponding to the triggered TXOP sharing mode field is the first value, it indicates that the AP shares the obtained TXOP with at least one other AP.

The first value may be a value greater than or equal to 3, or other preset fields other than 0-2. This is not limited here.

As an instance, the first AP sends a first MU-RTS TXS trigger frame. The first MU-RTS TXS trigger frame includes the Triggered TXOP sharing mode field. In a case where the identifier value of the triggered TXOP sharing mode field is 3, the first MU-RTS TXS trigger frame is configured to indicate the sharing of the transmission duration of the TXOP obtained by the first AP with the at least one second AP.

In the communication method applied to the first AP provided in an embodiment of the present disclosure, the first MU-RTS TXS trigger frame includes at least one first user information (user info) field. Each first user information field is configured to indicate transmission duration allocated to one second AP and a resource unit (RU) allocation method corresponding to the corresponding second AP.

The transmission duration allocated by the first AP to each second AP is part of the transmission duration of the TXOP obtained by the first AP, and is configured for Non-TB data transmission or P2P data transmission between the second AP and the associated STA.

The RU allocation method corresponding to each second AP is configured to denote a channel resource corresponding to the second AP based on the transmission duration allocated by the first AP.

In the communication method applied to the first AP provided in an embodiment of the present disclosure, each first user information field includes an association identifier (AID) field, a resource unit (RU) allocation field, and an allocation duration information field.

The association identifier field of the first user information field is configured to indicate an association identifier allocated by the first AP to the corresponding second AP in advance. In a case where the first MU-RTS TXS trigger frame is configured to indicate sharing of the transmission duration of the TXOP obtained by the first AP with one second AP, the first MU-RTS TXS trigger frame includes only one first user information field. The association identifier indicated by the association identifier field of the first user information field is a preset value, such as 2039. This is not limited here. In a case where the first MU-RTS TXS trigger frame is configured to indicate sharing of the transmission duration of the TXOP obtained by the first AP with a plurality of second APs, the association identifier field of the first user information field of the first MU-RTS TXS trigger frame corresponding to each second AP is configured to indicate an association identifier allocated by the first AP to the second AP in advance.

The RU allocation information field is configured to indicate an RU allocation method corresponding to the corresponding second AP. The allocation duration information field is configured to indicate the transmission duration allocated to the corresponding second AP.

As an instance, each first user information field may be expressed as follows:

| | | | |
|---|---|---|---|
| AID12 | RU Allocation | Allocation Duration | Reserved |

Specifically, AID12 is an association identifier field, RU allocation is an RU allocation information field, and allocation duration is an allocation duration information field.

In a case where the first MU-RTS TXS trigger frame is configured to indicate sharing of the transmission duration of the TXOP obtained by the first AP with one second AP, a receiving address of the first MU-RTS TXS trigger frame is an MAC address of the second AP.

In a case where the first MU-RTS TXS trigger frame is configured to indicate sharing of the transmission duration of the TXOP obtained by the first AP with a plurality of second APs, the receiving address of the first MU-RTS TXS trigger frame is a broadcast address corresponding to each second AP. That is, the first AP may send the first MU-RTS TXS trigger frame to each second AP using a broadcast method. In the communication method applied to the first AP provided in an embodiment of the present disclosure, a format of the first user information field includes a first format and a second format.

The first format and the second format are different information formats.

As an instance, the first user information field in the first format may be expressed as follows:

| | | | |
|---|---|---|---|
| AID12 | RU Allocation | Allocation Duration | Reserved |

As an instance, the first user information field in the second format may be expressed as follows:

| | | | | |
|---|---|---|---|---|
| AID12 | RU Allocation | Allocation Duration | Reserved | PS160 |

Primary/secondary 160 (PS160) is the same as field PS160 in a MU-RTS TXS trigger frame in the prior art.

In some examples, the first user information field in the first format may be referred to as an HE variant user info field. The first user information field in the second format may be referred to as an EHT variant user info field.

In some examples, the first user information field in the first format is configured to allocate the transmission duration of the TXOP to the second AP supporting a 160-MHz channel. The first user information field in the second format is configured to allocate the transmission duration of the TXOP to a second AP supporting a 320-MHz channel, a 480-MHz channel, or a 640-MHz channel.

That is, in terms of each second AP, in a case where the second AP supports the 160-MHz channel, the format of the first user information field of the first MU-RTS TXS trigger frame corresponding to the second AP is the first format. In a case where the second AP supports the 320-MHz channel, the 480-MHz channel or the 640-MHz channel, the format of the first user information field of the first MU-RTS TXS trigger frame corresponding to the second AP is the second format.

The first user information field for allocating the transmission duration of the TXOP to the second AP supporting the 480-MHz channel or the 640-MHz channel includes a second identifier bit. The second identifier bit indicates, using a second value, allocation of the transmission duration of the TXOP to the second AP supporting the 480-MHz channel, and indicates, using a third value, allocation of the transmission duration of the TXOP to the second AP supporting the 640-MHz channel.

The second identifier bit may be any bit of a reserved bit in the first user information field.

The second value and the third value are different values. For instance, the second value may be 0, and the third value may be 1. This is not limited here.

As an instance, in terms of any second AP supporting the 480-MHz channel, an identifier value of a second identifier bit of a reserved bit of the first user information field of the first MU-RTS TXS trigger frame corresponding to the second AP is 0. In terms of any second AP supporting the 640-MHz channel, the identifier value of the second identifier bit of the reserved bit of the first user information field of the first MU-RTS TXS trigger frame corresponding to the second AP is 1.

In the communication method applied to the first AP provided in an embodiment of the present disclosure, in cases where the first user information field in the first format is configured to allocate the transmission duration of the TXOP to the second AP supporting the 160-MHz channel and the first user information field in the second format is configured to allocate the transmission duration of the TXOP to the second AP supporting the 320-MHz channel, the 480-MHz channel or the 640-MHz channel, the first user information field for allocating the transmission duration of the TXOP to the second AP supporting the 160-MHz channel or the 320-MHz channel includes a third identifier bit. The third identifier bit indicates, using a fourth value, that primary channels of the corresponding second AP are a 20-MHz channel, a 40-MHz channel, and an 80-MHz channel, and indicates, using a fifth value, that the primary channels of the corresponding second AP are the 160-MHz channel, an (80+80)-MHz channel, and the 320 MHz-channel.

The fourth value and the fifth value are different values. For instance, the fourth value is 0, and the fifth value is 1. This is not limited here.

The third identifier bit may be bit B0 in an RU allocation information field of the first user information field.

As an instance, in terms of the second AP supporting the 160-MHz channel or the 320-MHz channel, the first user information field of the first MU-RTS TXS trigger frame corresponding to the second AP includes a third identifier bit. In a case where an identifier value of the third identifier bit is the fourth value, it indicates that the primary channels of the second AP are the 20-MHz channel, the 40-MHz channel, and the 80-MHz channel. In a case where the identifier value of the third identifier bit is the fifth value, it indicates that the primary channels of the second AP are the 160-MHz channel, the (80+80)-MHz channel, and the 320-MHz channel.

Moreover, the first user information field for allocating the transmission duration of the TXOP to the second AP supporting the 480-MHz channel or the 640-MHz channel includes a fourth identifier bit. The fourth identifier bit indicates, using a sixth value, that a primary channel of the corresponding second AP is the 480-MHz channel, and indicates, using a seventh value, that the primary channel of the corresponding second AP is the 640-MHz channel.

The third identifier bit and the fourth identifier bit are different bits in an RU allocation information field of the first user information field. For instance, the fourth identifier bit may be bit B1 in the RU allocation information field of the first user information field.

The sixth value and the seventh value are different values. For instance, the sixth value is 0, and the seventh value is 1. This is not limited here.

As an instance, in terms of the second AP supporting the 480-MHz channel or the 640-MHz channel, the first user information field of the first MU-RTS TXS trigger frame corresponding to the second AP includes the fourth identifier bit. In a case where an identifier value of the fourth identifier bit is the sixth value, it indicates that the primary channel of the second AP is the 480-MHz channel. In a case where the identifier value of the fourth identifier bit is the seventh value, it indicates that the primary channel of the second AP is the 640-MHz channel.

In the communication method applied to the first AP provided in an embodiment of the present disclosure, in a case where the first AP shares the transmission duration of the obtained TXOP with a plurality of second APs, that is, in a case where the first MU-RTS TXS trigger frame includes a plurality of first user information fields, transmission duration allocation methods corresponding to all second APs are time division multiple access (TDMA) methods. That is, the transmission duration allocated by the first AP to all the second APs corresponds to different time slots.

In some examples, RU allocation corresponding to all the second APs does not overlap.

In the communication method applied to the first AP provided in an embodiment of the present disclosure, after the first AP sends the first MU-RTS TXS trigger frame to each second AP, the method further includes: receiving a first clear to send (CTS) frame sent by each second AP, where the first CTS frame sent by each second AP is configured to respond to the first MU-RTS TXS trigger frame.

An embodiment of the present disclosure provides a communication method. The communication method may be applied to a target AP. Details can be obtained with reference to FIG. 5, and a flowchart of a communication method according to an embodiment of the present disclosure is shown in FIG. 5.

In some examples, the method may include the following step S51.

In step S51, a first MU-RTS TXS trigger frame is received, where the first MU-RTS TXS trigger frame is configured to indicate sharing of transmission duration of a TXOP obtained by the first AP with at least one second AP.

The first AP may share at least part of transmission duration of the TXOP obtained by the first AP with each second AP via the first MU-RTS TXS trigger frame.

The transmission duration shared by the first AP with each second AP is configured for Non-TB data transmission or P2P data transmission between the second AP and the associated STA.

The first AP and the second AP in an embodiment of the present disclosure are different physical entities. That is, the first AP is an AP other than the second AP. The target AP is any second AP.

In a case where the first AP shares the transmission duration of the TXOP obtained by the first AP with the target AP, the first AP may send the first MU-RTS TXS trigger frame based on a communication connection with the target AP. In a case where the first AP shares the transmission duration of the TXOP obtained by the first AP with a plurality of second APs, the first AP may send the first MU-RTS TXS trigger frame to each second AP based on a broadcast method.

In the communication method applied to the target AP provided in an embodiment of the present disclosure, the first MU-RTS TXS trigger frame includes a first identifier bit. The first identifier bit indicates, using a first value, the sharing of the transmission duration of the TXOP obtained by the first AP with the at least one second AP.

In some examples, the first MU-RTS TXS trigger frame includes a triggered TXOP sharing mode field. The triggered TXOP sharing mode field includes the first identifier bit. In a case where the identifier value of the first identifier bit of the first MU-RTS TXS trigger frame is the first value, it indicates the sharing of the transmission duration of the TXOP obtained by the first AP with the at least one second AP.

The first value may be a value greater than or equal to 3, or other preset fields other than 0-2. This is not limited here.

As an instance, the first AP sends a first MU-RTS TXS trigger frame. The first MU-RTS TXS trigger frame includes the Triggered TXOP sharing mode field. In a case where the identifier value of the triggered TXOP sharing mode field is 3, the first MU-RTS TXS trigger frame is configured to indicate the sharing of the transmission duration of the TXOP obtained by the first AP with the at least one second AP.

In the communication method applied to the target AP provided in an embodiment of the present disclosure, the first MU-RTS TXS trigger frame includes at least one first user information (user info) field. Each first user information field is configured to indicate transmission duration allocated to one second AP and a resource unit (RU) allocation method corresponding to the corresponding second AP.

The transmission duration allocated by the first AP to each second AP is part of transmission duration of the TXOP obtained by the first AP, and is configured for Non-TB data transmission or P2P data transmission between the second AP and the associated STA.

The RU allocation method corresponding to each second AP is configured to denote a channel resource corresponding to the second AP based on the transmission duration allocated by the first AP.

In the communication method applied to the target AP provided in an embodiment of the present disclosure, each first user information field includes an association identifier (AID) field, a resource unit (RU) allocation field, and an allocation duration information field.

The association identifier field is configured to indicate an association identifier allocated by the first AP to the corresponding second AP in advance. In a case where the first MU-RTS TXS trigger frame is configured to indicate sharing of the transmission duration of the TXOP obtained by the first AP with one second AP, the first MU-RTS TXS trigger frame includes only one first user information field. The association identifier indicated by the association identifier field of the first user information field is a preset value, such as 2039. This is not limited here. In a case where the first MU-RTS TXS trigger frame is configured to indicate sharing of the transmission duration of the TXOP obtained by the first AP with a plurality of second APs, the association identifier field of the first user information field of the first MU-RTS TXS trigger frame corresponding to each second AP is configured to indicate an association identifier allocated by the first AP to the second AP in advance.

The RU allocation information field is configured to indicate an RU allocation method corresponding to the corresponding second AP. The allocation duration information field is configured to indicate the transmission duration allocated to the corresponding second AP.

As an instance, each first user information field may be expressed as follows:

| | | | |
|---|---|---|---|
| AID12 | RU Allocation | Allocation Duration | Reserved |

Specifically, AID12 is an association identifier field, RU allocation is an RU allocation information field, and allocation duration is an allocation duration information field.

In a case where the first MU-RTS TXS trigger frame is configured to indicate sharing of the transmission duration of the TXOP obtained by the first AP with the target AP, a receiving address of the first MU-RTS TXS trigger frame is a MAC address of the target AP, and an identifier value of the association identifier field included in the first user information field of the first MU-RTS TXS trigger frame is a preset value. For instance, the preset value may be 2059. This is not limited here.

In a case where the first MU-RTS TXS trigger frame is configured to indicate sharing of the transmission duration of the TXOP obtained by the first AP with a plurality of second APs, the receiving address of the first MU-RTS TXS trigger frame is a broadcast address corresponding to each second AP. That is, the first AP may send the first MU-RTS TXS trigger frame to each second AP using a broadcast method. Moreover, the association identifier field of the first user information field of the first MU-RTS TXS trigger frame corresponding to each second AP is configured to indicate an association identifier allocated by the first AP to the second AP in advance.

In the communication method applied to the target AP provided in an embodiment of the present disclosure, a format of the first user information field includes a first format and a second format.

The first format and the second format are different information formats.

As an instance, the first user information field in the first format may be expressed as follows:

| | | | |
|---|---|---|---|
| AID12 | RU Allocation | Allocation Duration | Reserved |

As an instance, the first user information field in the second format may be expressed as follows:

| | | | | |
|---|---|---|---|---|
| AID12 | RU Allocation | Allocation Duration | Reserved | PS160 |

Primary/secondary 160 (PS160) is the same as field PS160 in a MU-RTS TXS trigger frame in the prior art.

In some examples, the first user information field in the first format may be referred to as an HE variant user info field. The first user information field in the second format may be referred to as an EHT variant user info field.

In some examples, the first user information field in the first format is configured to allocate the transmission duration of the TXOP to the second AP supporting a 160-MHz channel. The first user information field in the second format is configured to allocate the transmission duration of the TXOP to a second AP supporting a 320-MHz channel, a 480-MHz channel, or a 640-MHz channel.

That is, in terms of each second AP, in a case where the second AP supports the 160-MHz channel, the format of the first user information field of the first MU-RTS TXS trigger frame corresponding to the second AP is the first format. In a case where the second AP supports the 320-MHz channel, the 480-MHz channel or the 640-MHz channel, the format of the first user information field of the first MU-RTS TXS trigger frame corresponding to the second AP is the second format.

The first user information field for allocating the transmission duration of the TXOP to the second AP supporting the 480-MHz channel or the 640-MHz channel includes a second identifier bit. The second identifier bit indicates, using a second value, allocation of the transmission duration of the TXOP to the second AP supporting the 480-MHz channel, and indicates, using a third value, allocation of the transmission duration of the TXOP to the second AP supporting the 640-MHz channel.

The second identifier bit may be any bit of a reserved bit in the first user information field.

The second value and the third value are different values. For instance, the second value may be 0, and the third value may be 1. This is not limited here.

As an instance, in terms of any second AP supporting the 480-MHz channel, an identifier value of a second identifier bit of a reserved bit of the first user information field of the first MU-RTS TXS trigger frame corresponding to the second AP is 0. In terms of any second AP supporting the 640-MHz channel, the identifier value of the second identifier bit of the reserved bit of the first user information field of the first MU-RTS TXS trigger frame corresponding to the second AP is 1.

In the communication method applied to the target AP provided in an embodiment of the present disclosure, in cases where the first user information field in the first format is configured to allocate the transmission duration of the TXOP to the second AP supporting the 160-MHz channel and the first user information field in the second format is configured to allocate the transmission duration of the TXOP to the second AP supporting the 320-MHz channel, the 480-MHz channel or the 640-MHz channel, the first user information field for allocating the transmission duration of the TXOP to the second AP supporting the 160-MHz channel or the 320-MHz channel includes a third identifier bit. The third identifier bit indicates, using a fourth value, that primary channels of the corresponding second AP are a 20-MHz channel, a 40-MHz channel, and an 80-MHz channel, and indicates, using a fifth value, that the primary channels of the corresponding second AP are the 160-MHz channel, an (80+80)-MHz channel, and the 320 MHz-channel.

The fourth value and the fifth value are different values. For instance, the fourth value is 0, and the fifth value is 1. This is not limited here.

The third identifier bit may be bit B0 in an RU allocation information field of the first user information field.

As an instance, in terms of the second AP supporting the 160-MHz channel or the 320-MHz channel, the first user information field of the first MU-RTS TXS trigger frame corresponding to the second AP includes a third identifier bit. In a case where an identifier value of the third identifier bit is the fourth value, it indicates that the primary channels of the second AP are the 20-MHz channel, the 40-MHz channel, and the 80-MHz channel. In a case where the identifier value of the third identifier bit is the fifth value, it indicates that the primary channels of the second AP are the 160-MHz channel, the (80+80)-MHz channel, and the 320-MHz channel.

Moreover, the first user information field for allocating the transmission duration of the TXOP to the second AP supporting the 480-MHz channel or the 640-MHz channel includes a fourth identifier bit. The fourth identifier bit indicates, using a sixth value, that a primary channel of the corresponding second AP is the 480-MHz channel, and indicates, using a seventh value, that the primary channel of the corresponding second AP is the 640-MHz channel.

The third identifier bit and the fourth identifier bit are different bits in an RU allocation information field of the first user information field. For instance, the fourth identifier bit may be bit B1 in the RU allocation information field of the first user information field.

The sixth value and the seventh value are different values. For instance, the sixth value is 0, and the seventh value is 1. This is not limited here.

As an instance, in terms of the second AP supporting the 480-MHz channel or the 640-MHz channel, the first user information field of the first MU-RTS TXS trigger frame corresponding to the second AP includes the fourth identifier bit. In a case where an identifier value of the fourth identifier bit is the sixth value, it indicates that the primary channel of the second AP is the 480-MHz channel. In a case where the identifier value of the fourth identifier bit is the seventh value, it indicates that the primary channel of the second AP is the 640-MHz channel.

In the communication method applied to the target AP provided in an embodiment of the present disclosure, in a case where the first AP shares the transmission duration of the obtained TXOP with a plurality of second APs, that is, in a case where the first MU-RTS TXS trigger frame includes a plurality of first user information fields, transmission duration allocation methods corresponding to all second APs are time division multiple access (TDMA) methods. That is, transmission duration allocated by the first AP to all the second APs corresponds to different time slots.

In some examples, RU allocation corresponding to all the second APs do not overlap.

In the communication method applied to the target AP provided in an embodiment of the present disclosure, after the target AP receives the first MU-RTS TXS trigger frame sent by the first AP, the method further includes: sending a first clear to send (CTS) frame, where the first CTS frame sent by the target AP is configured to respond to the first MU-RTS TXS trigger frame.

The communication method applied to the target AP provided in an embodiment of the present disclosure further includes: determining a second MU-RTS TXS trigger frame, where the second MU-RTS TXS trigger frame is configured to share the transmission duration obtained by the target AP with at least one associated STA; and sending the second MU-RTS TXS trigger frame.

The transmission duration obtained by the target AP is part of the transmission duration of the TXOP obtained and shared by the first AP.

The transmission duration shared by the first AP with the target AP is configured for Non-TB data transmission or P2P data transmission between the target AP and the associated STA.

The target AP may send the second MU-RTS TXS trigger frame via a communication connection with each associated STA, or may send the second MU-RTS TXS trigger frame to each associated STA using a broadcast method.

In the communication method applied to the target AP provided in an embodiment of the present disclosure, the second MU-RTS TXS trigger frame includes at least one second user information field. Each second user information field is configured to indicate sharing of the transmission duration obtained by the target AP with one associated STA.

The method for sharing, by the target AP, the transmission duration obtained by the target AP with at least one associated STA is consistent with that in the prior art, and is not repeated here.

Each second user information field includes an allocation duration information field. The allocation duration information field is configured to indicate the transmission duration allocated by the target AP to the corresponding associated STA.

The transmission duration obtained by each associated STA is part or all of target transmission duration. That is, the transmission duration obtained by each associated STA is less than or equal to the target transmission duration. For instance, in a case where the target AP shares the obtained transmission duration with one associated STA, the transmission duration obtained by the associated STA is less than or equal to the target transmission duration. In a case where the target AP shares the obtained transmission duration with a plurality of associated STAs, the transmission duration obtained by each associated STA is less than the target transmission duration.

The target transmission duration is less than or equal to a difference between transmission duration obtained by the target AP and first transmission duration. The first transmission duration is a sum of the transmission duration of the first MU-RTS TXS trigger frame, transmission duration of the first CTS frame, and double short inter frame spaces (SIFS).

A short inter frame space exists between the first MU-RTS TXS trigger frame and the first CTS frame. A short inter frame space exists between the first CTS frame and the second MU-RTS TXS trigger frame.

As an instance, in a case where the target AP shares the obtained transmission duration with one associated STA, the transmission duration obtained by the associated STA (that is, transmission duration allocated by the allocation duration information field of the second user information field corresponding to the associated STA) is as follows: t1=t2−(t3+t4+2SIFS).

Specifically, t2 is the transmission duration obtained by the target AP, t3 is the transmission duration of the first MU-RTS TXS trigger frame, t4 is transmission duration of the first CTS frame, and SIFS is the short inter frame space.

In the communication method applied to the target AP provided in an embodiment of the present disclosure, after the target AP sends the second MU-RTS TXS trigger frame to at least one associated STA, the method further includes: receiving a second clear to send (CTS) frame sent by each associated STA, where each second CTS frame is configured to respond to the second MU-RTS TXS trigger frame.

An embodiment of the present disclosure provides a communication method. The communication method may be applied to a target STA. Details can be obtained with reference to FIG. 6, and a flowchart of a communication method according to an embodiment of the present disclosure is shown in FIG. 6.

In some examples, the method may include the following step S61.

In step S61, a network allocation vector is set to be in a busy state in a case of receiving a first MU-RTS TXS trigger frame sent by a first AP, where the first MU-RTS TXS trigger frame is configured to indicate sharing of transmission duration of a TXOP obtained by the first AP with at least one second AP.

The target STA is associated with any second AP. That is, in cases where the first AP shares the obtained transmission duration of the TXOP with at least one second AP via the first MU-RTS TXS trigger frame and each second AP shares the obtained transmission duration with at least one associated STA via the second MU-RTS TXS trigger frame, each associated STA of each second AP may monitor the MU-RTS TXS trigger frame.

In terms of the target STA, after receiving one MU-RTS TXS trigger frame, the target STA may parse the MU-RTS TXS trigger frame. In a case where it is determined, by a related parameter in the MU-RTS TXS trigger frame (that is, an association identifier field of the user information field), that the MU-RTS TXS trigger frame is a trigger frame sent by the first AP to at least one second AP, it indicates that the target STA is not a receiver of the MU-RTS TXS trigger frame. In this case, the target STA may set a network allocation vector (NAV) to be in a busy state, and then continues to keep a monitoring state.

The communication method applied to the target STA provided in an embodiment of the present disclosure further includes: setting the network allocation vector to be in the busy state in a case of receiving a second MU-RTS TXS trigger frame sent by a second AP other than the target AP.

The target AP is a second AP associated with the target STA.

In terms of the target STA, after receiving one MU-RTS TXS trigger frame, the target STA may parse the MU-RTS TXS trigger frame. In a case where it is determined, by a related parameter in the MU-RTS TXS trigger frame (that is, the association identifier field of the user information field), that the MU-RTS TXS trigger frame is a trigger frame sent by a second AP other than the target AP to an associated STA, it indicates that the target STA is not the receiver of the MU-RTS TXS trigger frame. In this case, the target STA may set a network allocation vector (NAV) to be in a busy state, and then continue to keep a monitoring state.

That is, after receiving a MU-RTS TXS trigger frame, the target STA may parse the MU-RTS TXS trigger frame, and determine, using a related parameter (such as the association identifier field of the user information field) in the MU-RTS TXS trigger frame, whether the target STA is a receiver of the MU-RTS TXS trigger frame. In a case where the target STA determines that the STA is not the receiver of the received MU-RTS TXS trigger frame, that is, determines that the MU-RTS TXS trigger frame is sent not by the target AP associated with the STA, the target STA may set a network allocation vector (NAV) to be in a busy state, and then continues to keep a monitoring state.

The communication method applied to the target AP provided in an embodiment of the present disclosure further includes: sending a second CTS frame to the target AP in a case of receiving a second MU-RTS TXS trigger frame sent by the target AP, where the second CTS frame is configured to respond to the second MU-RTS TXS trigger frame sent by the target AP.

At this time, the target AP no longer monitor the MU-RTS TXS trigger frame.

Further, in terms of the target STA, after receiving the second MU-RTS TXS trigger frame sent by the target AP, the target STA may determine the transmission duration allocated to the target STA by the target AP via the second MU-RTS TXS trigger frame, to perform Non-TB data transmission or P2P data transmission with the target AP based on the transmission duration.

Based on the communication method provided in an embodiment of the present disclosure, any AP can share the transmission duration of the obtained TXOP with another AP via a MU-RTS TXS trigger frame such that the another AP can share the obtained transmission duration with an associated STA via the MU-RTS TXS trigger frame for Non-TB data transmission or P2P data transmission.

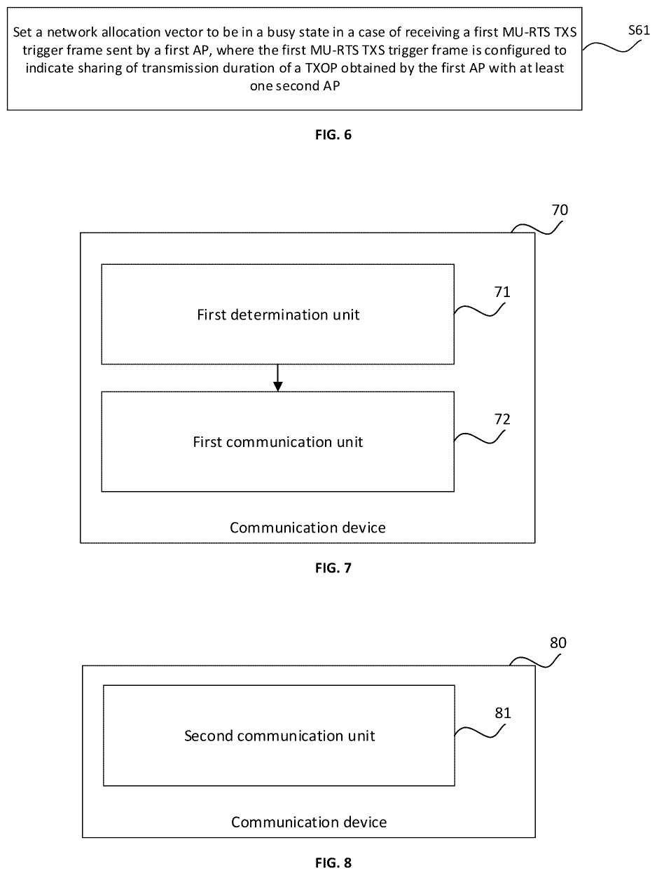

As shown in FIG. 7, an embodiment of the present disclosure provides a communication device. The communication device 70 includes a first determination unit 71 and a first communication unit 72.

The first determination unit 71 is configured to determine a first MU-RTS TXS trigger frame, where the first MU-RTS TXS trigger frame is configured to indicate sharing of transmission duration of a TXOP obtained by the first AP with at least one second AP.

The first communication unit 72 is configured to send the first MU-RTS TXS trigger frame.

In some examples, in an embodiment of the present disclosure, the first MU-RTS TXS trigger frame includes a first identifier bit. The first identifier bit indicates, using a first value, the sharing of the transmission duration of the TXOP obtained by the first AP with the at least one second AP.

In some examples, in an embodiment of the present disclosure, the first MU-RTS TXS trigger frame includes at least one first user information field. Each first user information field is configured to indicate transmission duration allocated to one second AP and a resource unit (RU) allocation method corresponding to the corresponding second AP.

In some examples, in an embodiment of the present disclosure, each first user information field includes an RU allocation information field and an allocation duration information field.

The RU allocation information field is configured to indicate the RU allocation method corresponding to the corresponding second AP.

The allocation duration information field is configured to indicate the transmission duration allocated by the first AP to the corresponding second AP.

In some examples, in an embodiment of the present disclosure, a format of the first user information field includes a first format and a second format. A first user information field in the first format is configured to allocate the transmission duration of the TXOP to the second AP supporting a 160-MHz channel. A first user information field in the second format is configured to allocate the transmission duration of the TXOP to a second AP supporting a 320-MHz channel, a 480-MHz channel or a 640-MHz channel.

The first user information field for allocating the transmission duration of the TXOP to the second AP supporting the 480-MHz channel or the 640-MHz channel includes a second identifier bit. The second identifier bit indicates, using a second value, allocation of the transmission duration of the TXOP to the second AP supporting the 480-MHz channel, and indicates, using a third value, allocation of the transmission duration of the TXOP to the second AP supporting the 640-MHz channel.

In some examples, in an embodiment of the present disclosure, the first user information field for allocating the transmission duration of the TXOP to the second AP supporting the 160-MHz channel or the 320-MHz channel includes a third identifier bit. The third identifier bit indicates, using a fourth value, that primary channels of the corresponding second AP are a 20-MHz channel, a 40-MHz channel, and an 80-MHz channel, and indicates, using a fifth value, that the primary channels of the corresponding second AP are the 160-MHz channel, an (80+80)-MHz channel, and the 320 MHz-channel.

The first user information field for allocating the transmission duration of the TXOP to the second AP supporting the 480-MHz channel or the 640-MHz channel includes a fourth identifier bit. The fourth identifier bit indicates, using a sixth value, that a primary channel of the corresponding second AP is the 480-MHz channel, and indicates, using a seventh value, that the primary channel of the corresponding second AP is the 640-MHz channel.

The third identifier bit and the fourth identifier bit are different bits in the RU allocation information field of the first user information field.

In some examples, in an embodiment of the present disclosure, transmission duration allocation methods corresponding to second APs are time division multiple access methods, and RU allocation corresponding to the second APs does not overlap.

In some examples, in an embodiment of the present disclosure, the first communication unit 72 is further configured to: receive a CTS frame sent by each second AP, where each first CTS frame is configured to respond to the first MU-RTS TXS trigger frame.

In some examples, in an embodiment of the present disclosure, each first user information field further includes an association identifier field. In a case where the first MU-RTS TXS trigger frame is configured to indicate sharing of the transmission duration of the TXOP with one second AP, an indication value of the association identifier field of the first user information field of the first MU-RTS TXS trigger frame is a preset value, and a receiving address of the first MU-RTS TXS trigger frame is an MAC address of the second AP. In a case where the first MU-RTS TXS trigger frame is configured to indicate sharing of the transmission duration of the TXOP with a plurality of second APs, an indication value of an association identifier field of a first user information field corresponding to each second AP is an association identifier allocated by the first AP for the corresponding second AP in advance, and the receiving address of the first MU-RTS TXS trigger frame is a broadcast address corresponding to each second AP.

As shown in FIG. 8, an embodiment of the present disclosure provides a communication device. The communication device 80 includes: a second communication unit 81 configured to receive a first MU-RTS TXS trigger frame, where the first MU-RTS TXS trigger frame is configured to indicate sharing of transmission duration of a TXOP obtained by a first AP with at least one second AP, and the target AP is any second AP.

In some examples, in an embodiment of the present disclosure, the first MU-RTS TXS trigger frame includes a first identifier bit. The first identifier bit indicates, using a first value, the sharing of the transmission duration of the TXOP obtained by the first AP with the at least one second AP.

In some examples, in an embodiment of the present disclosure, the first MU-RTS TXS trigger frame includes at least one first user information field. Each first user information field is configured to indicate transmission duration allocated to one second AP and a resource unit (RU) allocation method corresponding to the corresponding second AP.

In some examples, in an embodiment of the present disclosure, each first user information field includes an RU allocation information field and an allocation duration information field.

The RU allocation information field is configured to indicate the RU allocation method corresponding to the corresponding second AP.

The allocation duration information field is configured to indicate transmission duration allocated by the first AP to the corresponding second AP.

In some examples, in an embodiment of the present disclosure, a format of the first user information field includes a first format and a second format. A first user information field in the first format is configured to allocate the transmission duration of the TXOP to the second AP supporting a 160-MHz channel. A first user information field in the second format is configured to allocate the transmission duration of the TXOP to a second AP supporting a 320-MHz channel, a 480-MHz channel or a 640-MHz channel.

The first user information field for allocating the transmission duration of the TXOP to the second AP supporting the 480-MHz channel or the 640-MHz channel includes a second identifier bit. The second identifier bit indicates, using a second value, allocation of the transmission duration of the TXOP to the second AP supporting the 480-MHz channel, and indicates, using a third value, allocation of the transmission duration of the TXOP to the second AP supporting the 640-MHz channel.

In some examples, in an embodiment of the present disclosure, the first user information field for allocating the transmission duration of the TXOP to the second AP supporting the 160-MHz channel or the 320-MHz channel includes a third identifier bit. The third identifier bit indicates, using a fourth value, that primary channels of the corresponding second AP are a 20-MHz channel, a 40-MHz channel, and an 80-MHz channel, and indicates, using a fifth value, that the primary channels of the corresponding second AP are the 160-MHz channel, an (80+80)-MHz channel, and the 320 MHz-channel.

The first user information field for allocating the transmission duration of the TXOP to the second AP supporting the 480-MHz channel or the 640-MHz channel includes a fourth identifier bit. The fourth identifier bit indicates, using a sixth value, that a primary channel of the corresponding second AP is the 480-MHz channel, and indicates, using a seventh value, that the primary channel of the corresponding second AP is the 640-MHz channel.

The third identifier bit and the fourth identifier bit are different bits in the RU allocation information field of the first user information field.

In some examples, in an embodiment of the present disclosure, transmission duration allocation methods corresponding to second APs are time division multiple access methods, and RU allocation corresponding to the second APs does not overlap.

In some examples, in an embodiment of the present disclosure, the second communication unit 81 is configured to: send a first CTS frame, where each first CTS frame is configured to respond to the first MU-RTS TXS trigger frame.

In some examples, in an embodiment of the present disclosure, each first user information field further includes an association identifier field. In a case where the first MU-RTS TXS trigger frame is configured to indicate sharing of the transmission duration of the TXOP with the target AP, an indication value of the association identifier field of the first user information field of the first MU-RTS TXS trigger frame is a preset value, and a receiving address of the first MU-RTS TXS trigger frame is an MAC address of the target AP. In a case where the first MU-RTS TXS trigger frame is configured to indicate sharing of the transmission duration of the TXOP with a plurality of second APs, an indication value of an association identifier field of a first user information field corresponding to each second AP is an association identifier allocated by the first AP for the corresponding second AP in advance, and the receiving address of the first MU-RTS TXS trigger frame is a broadcast address corresponding to each second AP.

In some examples, in an embodiment of the present disclosure, the device further includes a second determination unit 82. The second determination unit 82 is further configured to: determine a second MU-RTS TXS trigger frame, where the second MU-RTS TXS trigger frame is configured to share the transmission duration obtained by the target AP with at least one associated STA.

The second communication unit 81 is further configured to: send the second MU-RTS TXS trigger frame.

In some examples, in an embodiment of the present disclosure, the second MU-RTS TXS trigger frame includes at least one second user information field. Each second user information field is configured to indicate sharing of the transmission duration obtained by the target AP with one associated STA.

Transmission duration obtained by each associated STA is part or all of target transmission duration. The target transmission duration is a difference between the transmission duration obtained by the target AP and first transmission duration. The first transmission duration is a sum of transmission duration of the first MU-RTS TXS trigger frame, transmission duration of the first CTS frame, and double short inter frame spaces.

The target AP responds to the first MU-RTS TXS trigger frame via the first CTS frame.

In some examples, in an embodiment of the present disclosure, the second communication unit 81 is configured to: receive a second CTS frame sent by each associated STA, where each second CTS frame is configured to respond to the second MU-RTS TXS trigger frame.

As shown in FIG. 9, an embodiment of the present disclosure provides a communication device. The communication device 90 includes: a third communication unit 91 configured to set a network allocation vector to be in a busy state in a case of receiving a first MU-RTS TXS trigger frame sent by a first AP, where the first MU-RTS TXS trigger frame is configured to indicate sharing of transmission duration of a TXOP obtained by the first AP with at least one second AP, and the target STA is associated with any second AP.

In some examples, in an embodiment of the present disclosure, the third communication unit 91 is further configured to: set the network allocation vector to be in the busy state in a case of receiving a second MU-RTS TXS trigger frame sent by a second AP other than the target AP; and send a second CTS frame to the target AP in a case of receiving a second MU-RTS TXS trigger frame sent by the target AP, where the second CTS frame is configured to respond to the second MU-RTS TXS trigger frame sent by the target AP.

The target AP is a second AP associated with the target STA.

In some examples, in an embodiment of the present disclosure, in a case of receiving the second MU-RTS TXS trigger frame sent by the target AP, the third communication unit 91 is further configured to: perform data transmission with the target AP according to the transmission duration allocated by the target AP.

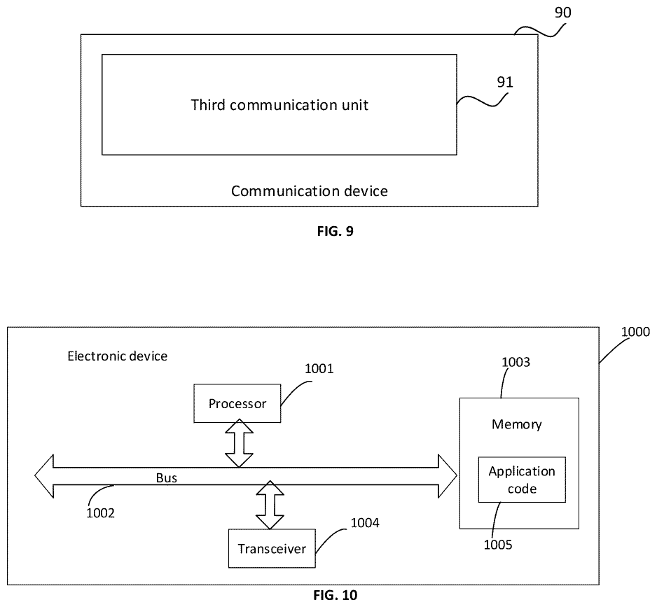

An embodiment of the present disclosure further provides an electronic device. As shown in FIG. 10, the electronic device 1000 shown in FIG. 10 includes a processor 1001 and a memory 1003. The processor 1001 is connected to the memory 1003, for instance, by a bus 1002. In some examples, the electronic device 1000 may further include a transceiver 1004. It should be noted that during practical application, a number of the transceiver 1004 is not limited to one. The structure of the electronic device 1000 does not constitute a limitation on an embodiment of the present disclosure.

The memory 1003 is configured to store an application code 1005 for implementing embodiments of the present disclosure, and is controlled by the processor 1001 for implementation. In a case where the electronic device 1000 serves as a first AP, the processor 1001 is configured to execute the application code 1005 stored in the memory 1003, to implement the communication method applied to the first AP provided in an embodiment of the present disclosure. In a case where the electronic device 1000 serves as a target AP, the processor 1001 is configured to execute the application code 1005 stored in the memory 1003, to implement the communication method applied to the target AP provided in an embodiment of the present disclosure. In a case where the electronic device 1000 serves as a target STA, the processor 1001 is configured to execute the application code 1005 stored in the memory 1003, to implement the communication method applied to the target STA provided in an embodiment of the present disclosure.

As used herein, the term processor may refer to one processor that performs the defined functions or a plurality of processors that collectively perform defined functions, such that the execution of the individual defined functions may be divided amongst such processors.

The bus 1002 may include a path to transfer information between the above components. The bus 1002 may be a peripheral component interconnect (PCI) bus, or an extended industry standard architecture (EISA) bus, etc. The bus 1002 may be classified into an address bus, a data bus, a control bus, etc. For convenience of notation, only one bold line is used in FIG. 10. However, it does not mean that only one bus or only one type of bus exists.

The memory 1003 may be a read-only memory (ROM) or another type of static storage device that can store static information and instructions, a random access memory (RAM) or another type of dynamic storage device that can store information and instructions, an electrically erasable programmable read-only memory (EEPROM), a compact disc read-only memory (CD-ROM) or another compact disc storage, an optical disc storage (including a compressed optical disc, a laser disc, an optical disc, a digital versatile optical disc, and a blu-ray disc), a magnetic disc storage medium or another magnetic storage device, or another medium that can be configured to carry or store a desired program code in the form of an instruction or a data structure and can be accessed by a computer. This is not limited here.

An embodiment of the present disclosure provides a computer-readable storage medium. The computer-readable storage medium stores a computer program. The computer program, when run on a computer, causes the computer to execute corresponding content in the above method embodiment.

It should be understood that although various steps in the flowcharts of the accompanying drawings are shown sequentially as indicated by the arrows, the steps are not certainly performed sequentially in a sequence indicated by the arrows. Unless explicitly stated here, these steps are not strictly limited to the sequence in which they are performed, and may be performed in another sequence. Moreover, at least some steps in the flowcharts of the accompanying drawings may include a plurality of sub-steps or stages. These sub-steps or stages are not certainly performed at the same time, but may be performed at different times. The sub-steps or stages are not certainly performed sequentially, but may be performed in turn or alternately with other steps or at least some sub-steps or stages of other steps.

It should be noted that the computer-readable storage medium in the present disclosure may be a computer-readable signal medium, a computer-readable storage medium, or any combinations of the foregoing. The computer-readable storage medium may be but is not limited to an electrical, magnetic, optical, electromagnetic, infrared, or semiconductor system, apparatus, or device, or any combinations of the foregoing. More particular instances of the computer-readable storage medium may include but are not limited to an electrical connector having one or more wires, a portable computer disk, a hard disk, a random access memory (RAM), a read only memory (ROM), an erasable programmable read only memory (EPROM or a flash memory), an optical fiber, a compact disc read only memory (CD-ROM), an optical storage device, a magnetic storage device, or any proper combinations of the foregoing. In the present disclosure, the computer-readable storage medium may be any tangible medium including or storing a program. The program may be used by or in combination with an instruction execution system, apparatus, or device. In the present disclosure, a computer-readable signal medium may include a data signal propagated in a baseband or as a portion of a carrier wave, and a computer-readable program code is carried in the data signal. Such a propagated data signal may be in a plurality of forms. The forms include but are not limited to an electromagnetic signal, an optical signal, and any proper combination of the foregoing. The computer-readable signal medium may alternatively be any computer-readable medium rather than a computer-readable storage medium. The computer-readable signal medium may send, propagate, or transmit a program that is used by or in combination with an instruction execution system, apparatus, or device. The program code included in the computer-readable storage medium may be transmitted by any appropriate media. The media include but are not limited to a wire, an optical cable, a radio frequency (RF), etc., and any proper combinations of the foregoing.

The computer-readable storage medium may be included in the first AP, the target AP, or the target STA, or may exist independently without being assembled into the first AP, the target AP, or the target STA.

The computer-readable storage medium carries one or more programs. When the one or more programs are executed by the first AP, the target AP, or the target STA, the first AP, the target AP, or the target STA performs a corresponding communication method.

Another aspect of the present disclosure further provides a computer program product or a computer program. The computer program product or the computer program includes computer instructions. The computer instructions are stored in a computer-readable storage medium. A processor of a computer device reads the computer instructions from the computer-readable storage medium. The processor executes the computer instructions to cause the computer device to perform the communication method provided in various optional implementations mentioned above.

The computer program code for executing an operation in the present disclosure may be written in one or more type of programming languages or their combinations. The above programming languages include object oriented programming languages such as Java, Smalltalk, and C++, and conventional procedural programming languages such as a “C” language or similar programming languages. The program code may be entirely executed on a user computer, may be partially executed on a user computer as an independent software package, may be partially executed on a user computer and partially executed on a remote computer, or may be entirely executed on a remote computer or server. In a case where the remote computer is involved, the remote computer may be connected to the user computer by any type of network, which include a local area network (LAN) or a wide area network (WAN), or may be connected to an external computer (for instance, by an internet service provider by the internet).

Flowcharts and block diagrams in accompanying drawings show system architectures, functions, and operations that may be implemented according to systems, methods, and computer program products in various embodiments of the present disclosure. In this regard, each block in flowcharts or block diagrams may denote a module, a program segment, or a portion of a code, which include one or more executable instructions for implementing specified logical functions. In some implementations taken as substitutes, functions annotated in blocks may alternatively occur in a sequence different from that annotated in figures. For instance, two blocks shown in succession may be actually performed basically in parallel, and sometimes may be performed in a reverse sequence. This is determined by a function involved. It should also be noted that each block in block diagrams and/or flowcharts, and combinations of the blocks in the block diagrams and/or flowcharts can be implemented by dedicated hardware-based systems that execute specified functions or operations, or can be implemented by combinations of dedicated hardware and computer instructions.

Involved modules described in embodiments of the present disclosure may be implemented in a form of software or hardware. The name of the module does not constitute a limitation on the module in some cases. For instance, module A may alternatively be described as “module A for performing operation B.”

The above description is merely illustrative of preferred embodiments of the present disclosure and employed technical principles. A person skilled in the art should understand that the disclosed scope involved in the present disclosure is not limited to technical solutions formed by specific combinations of the above technical features, and should further cover other technical solutions formed by any combinations of the above technical features or their equivalent features without departing from the inventive concept, such as technical solutions formed by interchanging the above features and technical features having similar functions as disclosed (but not limited) in the present disclosure.

1. A method, performed by a first access point (AP), the method comprising:
determining a first multi-user request-to-send transmission opportunity sharing (MU-RTS TXS) trigger frame, wherein the first MU-RTS TXS trigger frame is configured to indicate sharing of transmission duration of a transmission opportunity (TXOP) obtained by the first AP with at least one second AP; and
sending the first MU-RTS TXS trigger frame.

2. The method according to claim 1, wherein the first MU-RTS TXS trigger frame comprises a first identifier bit, and the first identifier bit indicates, using a first value, the sharing of the transmission duration of the TXOP obtained by the first AP with the at least one second AP.

3. The method according to claim 1, wherein the first MU-RTS TXS trigger frame comprises at least one first user information field, and each first user information field is configured to indicate transmission duration allocated to one second AP and a resource unit (RU) allocation method corresponding to the corresponding second AP.

4. The method according to claim 3, wherein each first user information field comprises an RU allocation information field and an allocation duration information field;
the RU allocation information field is configured to indicate the RU allocation method corresponding to the corresponding second AP; and
the allocation duration information field is configured to indicate transmission duration allocated by the first AP to the corresponding second AP.

5. The method according to claim 3, wherein a format of the first user information field comprises a first format and a second format, the first user information field in the first format is configured to allocate the transmission duration of the TXOP to a second AP supporting a 160-MHz channel, and the first user information field in the second format is configured to allocate the transmission duration of the TXOP to a second AP AP supporting a 320-MHz channel, a 480-MHz channel or a 640-MHz channel; and
the first user information field for allocating the transmission duration of the TXOP to the second AP supporting the 480-MHz channel or the 640-MHz channel comprises a second identifier bit, the second identifier bit indicates, using a second value, allocation of the transmission duration of the TXOP to the second AP supporting the 480-MHz channel, and the second identifier bit indicates, using a third value, allocation of the transmission duration of the TXOP to the second AP supporting the 640-MHz channel.

6. The method according to claim 5, wherein the first user information field for allocating the transmission duration of the TXOP to the second AP supporting the 160-MHz channel or the 320-MHz channel comprises a third identifier bit, the third identifier bit indicates, using a fourth value, that primary channels of the corresponding second AP are a 20-MHz channel, a 40-MHz channel, and an 80-MHz channel, and the third identifier bit indicates, using a fifth value, that the primary channels of the corresponding second AP are the 160-MHz channel, an (80+80)-MHz channel, and the 320 MHz-channel;
the first user information field for allocating the transmission duration of the TXOP to the second AP supporting the 480-MHz channel or the 640-MHz channel comprises a fourth identifier bit, the fourth identifier bit indicates, using a sixth value, that a primary channel of the corresponding second AP is the 480-MHz channel, and the fourth identifier bit indicates, using a seventh value, that the primary channel of the corresponding second AP is the 640-MHz channel; and
the third identifier bit and the fourth identifier bit are different bits in the RU allocation information field of the first user information field.

7. The method according to claim 4, wherein transmission duration allocation methods corresponding to each of second APs are time division multiple access methods, and RU allocation corresponding to each of the second APs does not overlap.

8. (canceled)

9. The method according to claim 3, wherein each first user information field further comprises an association identifier field;
in response the first MU-RTS TXS trigger frame is-being configured to indicate sharing of the transmission duration of the TXOP with one second AP, an indication value of the association identifier field of the first user information field of the first MU-RTS TXS trigger frame is a preset value, and a receiving address of the first MU-RTS TXS trigger frame is a MAC address of the second AP; and
in response to the fact that the first MU-RTS TXS trigger frame is-being configured to indicate sharing of the transmission duration of the TXOP with a plurality of second APs, an indication value of the association identifier field of the first user information field corresponding to each second AP is an association identifier allocated by the first AP for the corresponding second AP in advance, and the receiving address of the first MU-RTS TXS trigger frame is a broadcast address corresponding to each second AP.

10. A method, performed by a target access point (AP), comprising:
receiving a first multi-user request-to-send transmission opportunity sharing (MU-RTS TXS) trigger frame, wherein the first MU-RTS TXS trigger frame is configured to indicate sharing of transmission duration of a transmission opportunity (TXOP) obtained by a first AP with at least one second AP, and the target AP is any second AP.

11. The method according to claim 10, wherein the first MU-RTS TXS trigger frame comprises a first identifier bit, and the first identifier bit indicates, using a first value, the sharing of the transmission duration of the TXOP obtained by the first AP with the at least one second AP.

12. The method according to claim 10, wherein the first MU-RTS TXS trigger frame comprises at least one first user information field, and each first user information field is configured to indicate transmission duration allocated to one second AP and a resource unit (RU) allocation method corresponding to the corresponding second AP.

13. The method according to claim 12, wherein each first user information field comprises an RU allocation information field and an allocation duration information field;
the RU allocation information field is configured to indicate the RU allocation method corresponding to the corresponding second AP; and
the RU allocation duration information field is configured to indicate transmission duration allocated by the first AP to the corresponding second AP.

14.-15. (canceled)

16. The method according to claim 13, wherein transmission duration allocation methods corresponding to each of second APs are time division multiple access methods, and RU allocation corresponding to each of the second APs does not overlap.

17. (canceled)

18. The method according to claim 12, wherein each first user information field further comprises an association identifier field;
in response to the fact that the first MU-RTS TXS trigger frame is-being configured to indicate sharing of the transmission duration of the TXOP with the target AP, an indication value of the association identifier field of the first user information field of the first MU-RTS TXS trigger frame is a preset value, and a receiving address of the first MU-RTS TXS trigger frame is a MAC address of the target second AP; and
in response to the fact that the first MU-RTS TXS trigger frame is-being configured to indicate sharing of the transmission duration of the TXOP with a plurality of second APs, an indication value of the association identifier field of the first user information field corresponding to each second AP is an association identifier allocated by the first AP for the corresponding second AP in advance, and the receiving address of the first MU-RTS TXS trigger frame is a broadcast address corresponding to each second AP.

19. (canceled)

20. The method according to claim 18, wherein the second MU-RTS TXS trigger frame comprises at least one second user information field, and each second user information field is configured to indicate sharing of the transmission duration obtained by the target AP with one associated station (STA);
transmission duration obtained by each associated STA is part or all of target transmission duration, the target transmission duration is a difference between the transmission duration obtained by the target AP and first transmission duration, and the first transmission duration is a sum of transmission duration of the first MU-RTS TXS trigger frame, transmission duration of the first CTS frame, and double short inter frame spaces; and
the target AP responds to the first MU-RTS TXS trigger frame via the first CTS frame.

21. (canceled)

22. A method performed bya target station (STA), the method comprising:
setting a network allocation vector to be in a busy state in a case of receiving a first multi-user request-to-send transmission opportunity sharing (MU-RTS TXS) trigger frame sent by a first access point (AP), wherein the first MU-RTS TXS trigger frame is configured to indicate sharing of transmission duration of a transmission opportunity (TXOP) TXOP obtained by the first AP with at least one second AP, and the target STA is associated with any second AP.

23. The method according to claim 22, further comprising:
setting the network allocation vector to be in the busy state in a case of receiving a second MU-RTS TXS trigger frame sent by a second AP other than a target AP; and
sending a second clear to send (CTS) CTS frame to the target AP in a case of receiving a second MU-RTS TXS trigger frame sent by the target AP, wherein the second CTS frame is configured to respond to the second MU-RTS TXS trigger frame sent by the target AP; wherein
the target AP is a second AP associated with the target STA.

24-27. (canceled)

28. An electronic device, comprising:
one or more processors; and
a memory that stores a computer program,
wherein t the computer program, when, collectively executed by the one or more processors, causes the electronic device to act as the first AP and performs the method according to claim 1.

29. (canceled)

30. An electronic device, comprising:
one or more processors; and
a memory that stores a computer program,
wherein the computer program, when collectively executed by the one or more processors, causes the electronic device to act as the target AP and performs the method according to claim 10.

31. An electronic device, comprising:
one or more processors; and
a memory that stores a computer program,
wherein the computer program, when collectively executed by the one or more processors, causes the electronic device to act as the target STA and performs the method according to claim 22.
